(19) United States
(12) Patent Application Publication
(10) Pub. No.: US 2008/0128400 A1
(43) Pub. Date: Jun. 5, 2008

(54) MODULAR ROBOTIC WELD SYSTEM

(75) Inventors: Alfred C. Michels, Lisbon, ND (US); Shannon D. Snell, Alexandria, MN (US); Rory D. Lien, Lisbon, ND (US); Robert D. Waletzko, Lisbon, ND (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: CLARK EQUIPMENT COMPANY, West Fargo, ND (US)

(21) Appl. No.: 11/948,227

(22) Filed: Nov. 30, 2007

Related U.S. Application Data
(60) Provisional application No. 60/867,934, filed on Nov. 30, 2006.

(51) Int. Cl. B23K 37/00

(52) U.S. Cl. 219/148; 219/162; 901/50

(57) ABSTRACT

A weld assembly includes a fixture having a plurality of mounting mechanisms and a plurality of modular welding skids operable in concert with one another to perform coordinated welding functions. Each welding skid includes a base configured for coupling to a vehicle for transport, a robotic weld arm supported on the base and a power supply supported on the base for supplying power to the robotic arm. A dedicated controller supported on the base for controlling operation of the robotic weld arm. Each welding skid also includes at least one drop for receiving a utility external to the welding skid and a mounting flange configured for coupling the base to at least one of the mounting mechanisms of the fixture.

### RELATED APPLICATION

This application claims the benefit of U.S. Provisional Patent Application 60/867,934, filed on Nov. 30, 2006, the entire disclosure of which is hereby incorporated herein by reference.

### FIELD OF THE INVENTION

The present invention relates to a welding machine. More particularly, the present invention relates to a robotic welding skid used to weld components.

### SUMMARY

In one embodiment, the invention provides a robotic welding skid for performing welding functions including a base configured for coupling to a vehicle for transport, a robotic weld arm supported on the base and a power supply supported on the base for supplying power to the robotic arm. A dedicated controller is supported on the base for controlling operation of the robotic weld arm. The welding skid also includes at least one drop for receiving a utility external to the welding skid and a mounting flange configured for coupling the base to a fixture.

In another embodiment, the invention provides a weld assembly including a fixture having a plurality of mounting mechanisms and a plurality of modular welding skids operable in concert with one another to perform coordinated welding functions. Each welding skid includes a base configured for coupling to a vehicle for transport, a robotic weld arm supported on the base and a power supply supported on the base for supplying power to the robotic arm. A dedicated controller supported on the base for controlling operation of the robotic weld arm. Each welding skid also includes at least one drop for receiving a utility external to the welding skid and a mounting flange configured for coupling the base to at least one of the mounting mechanisms of the fixture.

In still another embodiment, the invention provides a method of assembling a plurality of robotic weld arms for working in concert with one another to perform welding functions on a component. Each welding skid includes a base configured for coupling to a vehicle for transport, a robotic weld arm supported on the base, a power supply supported on the base for supplying power to the robotic arm, a dedicated controller supported on the base for controlling operation of the robotic weld arm and at least one drop for receiving a utility external to the welding skid, the method comprising. The method includes the steps of affixing a fixture to a support surface, coupling a first welding skid to the fixture, programming the controller of the first welding skid to operate the robotic weld arm of the first welding skid to perform desired welding functions, coupling a second welding skid to the fixture and programming the controller of the second welding skid to operate the robotic weld arm of the second welding skid to perform desired welding functions, the controller of the second welding skid operating independently of the first welding skid.

Other aspects of the invention will become apparent by consideration of the detailed description and accompanying drawings.

### BRIEF DESCRIPTION OF THE DRAWINGS

FIG. 1 is a perspective view of a welding skid in accordance with an embodiment of the invention.

FIG. 2 is a side view of the welding skid of FIG. 1.

FIG. 3 is a top view of the welding skid of FIG. 1.

FIG. 4 is a front view of the welding skid of FIG. 1.

FIG. 5 is a rear view of the welding skid of FIG. 1.

FIG. 6 is a perspective view of the welding skid of FIG. 1 coupled to a fixture.

FIG. 7 is a perspective view of a welding assembly according to an embodiment of the invention.

FIG. 8 is an expanded view of a portion of the welding skid of FIG. 1 de-coupled from a fixture.

FIG. 9 is an expanded view of the welding skid of FIG. 8 coupled to the fixture.

FIG. 10 is a partial cross-sectional view of the welding skid and fixture of FIG. 9 taken along line X-X.

FIG. 11 is an expanded perspective view of the mounting mechanism of FIG. 9

FIG. 12 is a cross-sectional view of the mounting mechanism of FIG. 11 taken along line 12-12.

FIG. 13 is a perspective view of a welding skid according to another embodiment of the invention.

FIG. 14 is a perspective view of the modular robotic weld system of FIG. 13 coupled to a fixture.

FIG. 15 is an expanded view of a portion of the welding skid and fixture of FIG. 14.

FIG. 16 is an expanded view of the mounting flange of FIG. 15.

FIG. 17 is an expanded view of the fixture of FIG. 15.

FIG. 18 is an expanded view of the mounting flange coupled to the fixture of FIG. 15.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

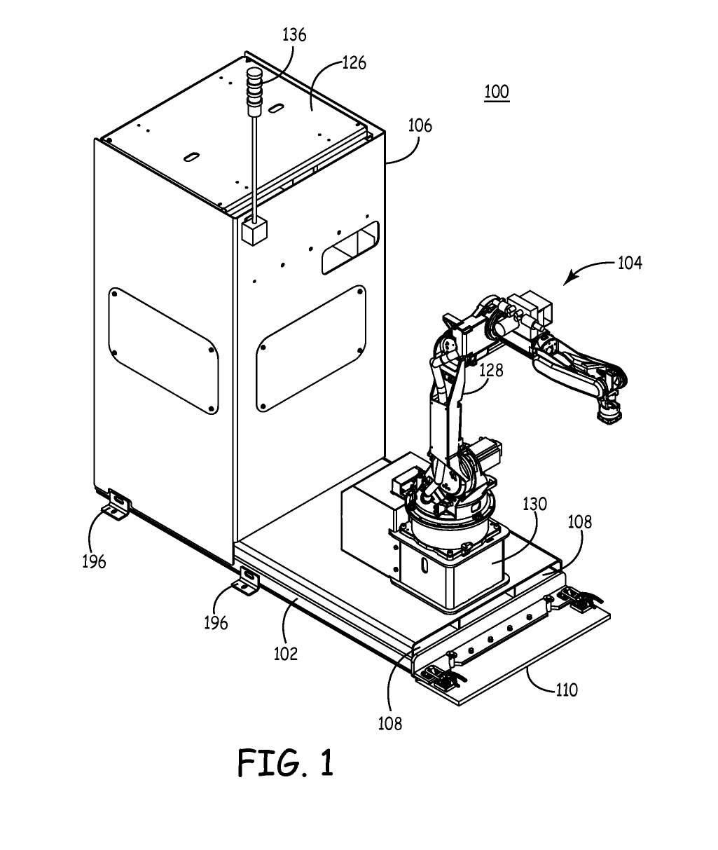

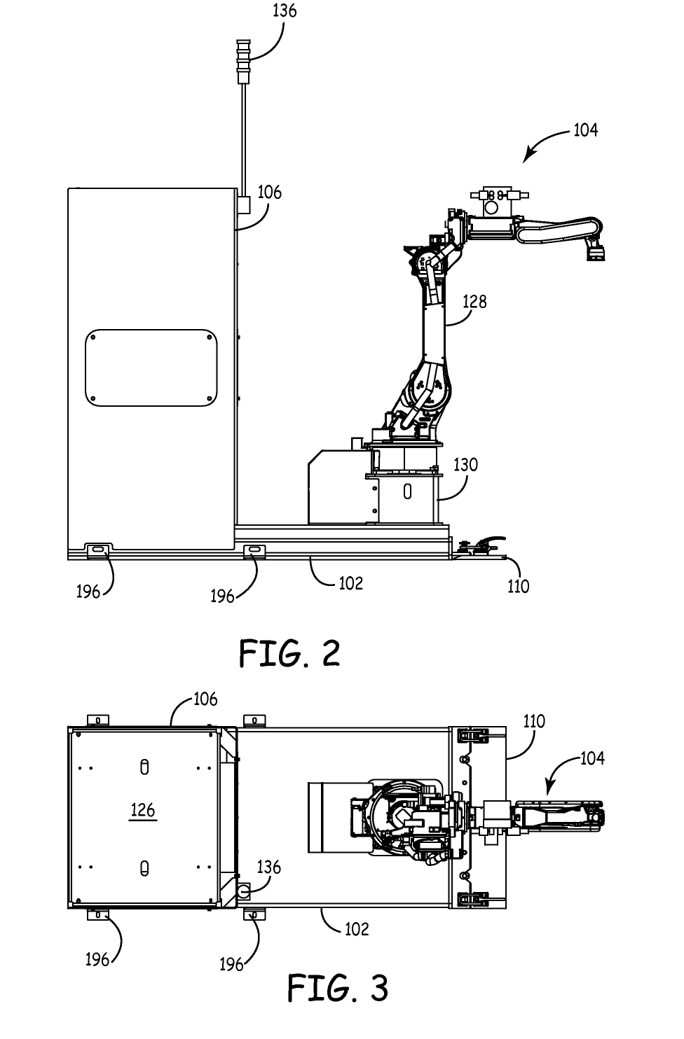

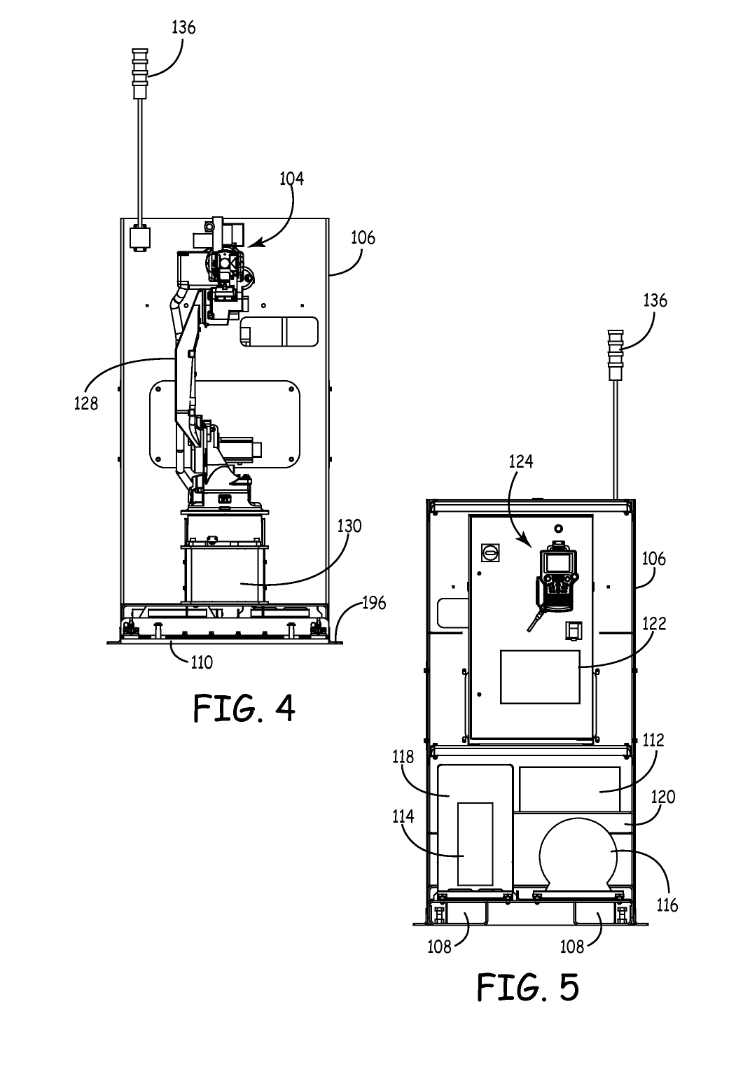

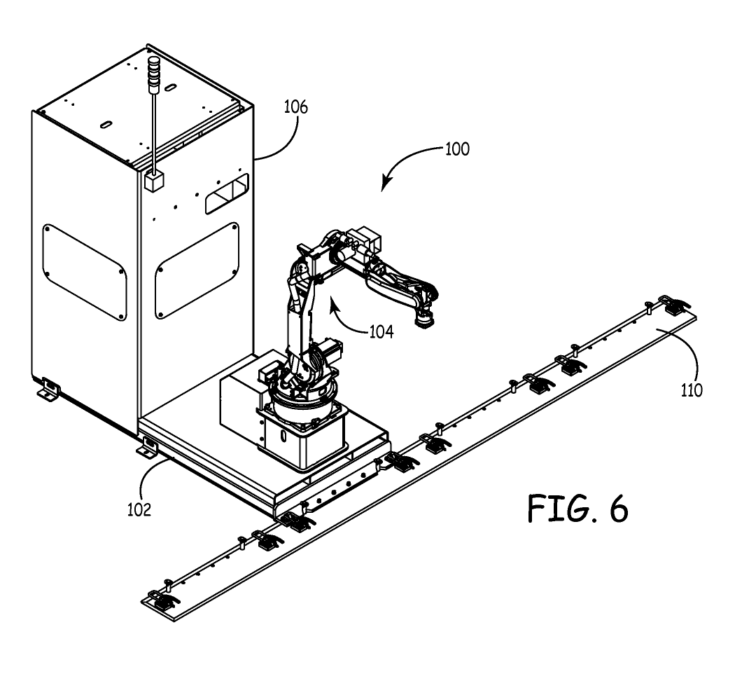

FIGS. 1-5 illustrate various views of a welding skid 100 in accordance with embodiments of the invention. The welding skid 100, in which various components are packaged together onto a single, movable platform, is used to perform robotic welding functions. The welding skid 100 may be individually packaged as its own platform or skid, or it may be combined with one or more welding skids on a common platform. One or more welding skids 100 may be used alone or in combination to perform high volume, complex welding functions.

Welding skid 100 includes a base 102 supporting a weld robot 104 and a cabinet 106. The weld robot 104 has a robotic arm 128 positioned on a riser 130 in front of the cabinet 106. The base 102 is configured for coupling to a transport vehicle for moving and positioning the welding skid 100. In the illustrated embodiment, the base 102 includes a standardized dimension that allows for the engagement of a fork lift-type vehicle for transport of the welding skid 100. Therefore, base 102 includes stake packets 108 to facilitate transport by a fork lift. The welding skid 100 is shown coupled to a fixture 110.

Various components can be located within the cabinet 106, including such components as are commonly employed in conjunction with a weld robot, including, for example, a weld power supply 112 for supplying power to the weld robot 104, a wire feeder 114 that feeds wire from a weld wire spool 116 to the weld robot 104, a weld torch water cooler 118, a reamer 120, a controller 122, and an electrical disconnect panel 124. All or a portion of a rear of the cabinet 106, illustrated in FIG. 5, can be open to permit access to components stored within the cabinet 106. In alternate embodiments, one or more components can be located outside of the cabinet 106. For example, the weld power supply 112 can be mounted to an outer wall of the cabinet 106 for ease of access. In another example, the weld wire spool 116 can be located on a top wall or roof 126 of the cabinet 106 for ease of access.

All utilities, such as power, compressed air and shielding gas, are provided to various of the components supported on the base 102 and are routed internal to base 102 and/or the cabinet 106. Specifically, these utilities can be located at a common location and can use a combined drop 136. For example, combined drop 136 can include conduits or other connectors for receiving electric power, compressed air, gas and water or other fluids. In other embodiments, the weld skid 100 includes multiple drops 136 for connecting to various utilities.

Welding skid 100 includes all of the components needed for operation of the robot arm 128 to perform welding functions. Controller 122 can be configured to control the movement and action of weld robot 104. In addition, controller 122 also controls various functions of providing weld material to robot 104. For example, all aspects of supplying power from weld power supply 112 and cooling the weld torch on robotic arm 128 with weld torch water cooler 118 are controlled by controller 122.

Controller 122 can be a standalone control system that controls operation of the weld robot 104 without requiring external input. In this manner, welding skid 100 can be considered a self-contained or independent weld system. That is, welding skid 100 can be used to perform welding functions independently of other assembly and/or manufacturing skids, cells or systems within a manufacturing process. In some embodiments, the controller 122 is dedicated. By dedicated, it is meant that the controller 122 is capable of controlling operation of all features of the weld robot 104 without input from the other machines in the assembly process.

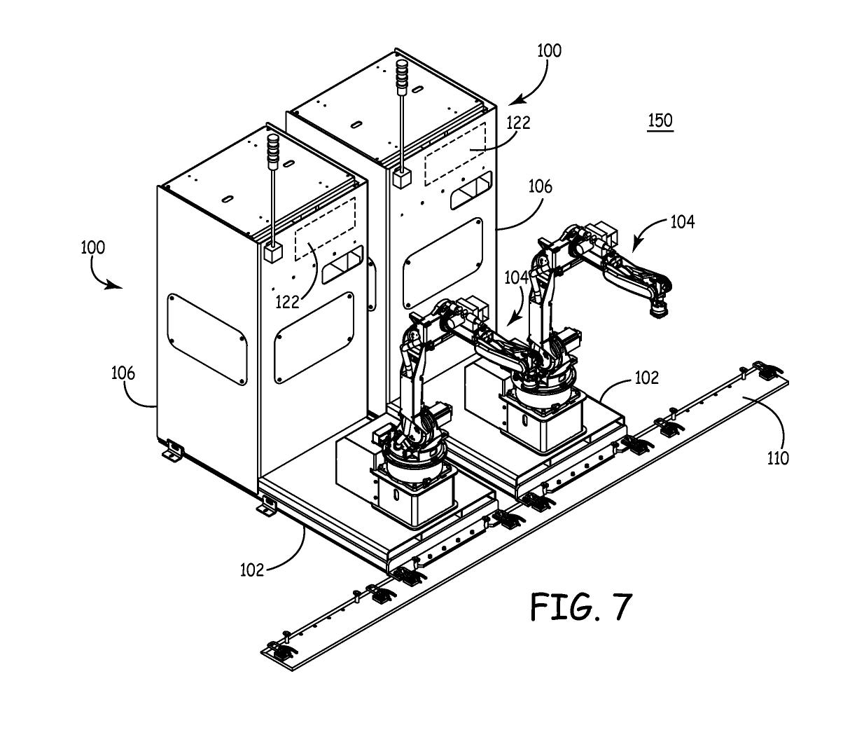

FIG. 7 shows a plurality of welding skids 100 that can be used in concert with one another to form a weld assembly 150 to increase welding capacity. As shown in FIG. 7, a second welding skid 100 can be positioned adjacent an existing welding skid 100 to increase the speed at which welding is carried out. For example, rather than employing one weld robot 104 to perform all welding functions on a given component, the left hand weld robot 104 can perform welding functions on the left side of the component and the right hand weld robot can perform welding functions on the right side of the component. While such an assembly configuration may require the controller 122 associated with each welding skid 100 to be programmed uniquely (for example, to avoid interfering with each other's movements), each of the controllers 122 can be remain dedicated. That is, each of the controllers 122 is programmed and carries out control functions with little or no communication with the controller 122 of other welding skids 100 in the welding assembly 150. As illustrated in FIG. 7, the welding skids 100 are not directly connected to one another nor are their associated controllers 122. Rather, each welding skid 100 is merely mechanically coupled to the fixture 110 for positioning and stability.

Additional welding skids 100 can be added to or taken away from the weld assembly 150 quickly and easily to increase or decrease capacity as needed. Furthermore, should the operation of one welding skid 100 in the weld assembly 150 cease unexpectedly, the affected welding skid 100 can be easily removed and replaced with another welding skid 100. Because each welding skid 100 has dedicated controls, the controllers 122 of each welding skid 100 in the weld assembly 150 need not be significantly reprogrammed to work in concert with the replacement welding skid 100. This can significantly reduce weld assembly 150 downtime.

The weld assembly 150 is easily transportable, reconfigurable and has a high degree of commonality between individual welding skids 100. Specifically, each of the welding skids 100 in the welding assembly 150 are identical to one another, but perform different welding functions according to the programming or settings of the individual controllers 122. In some embodiments, however, a first welding skid 100 (i.e., a “master”) includes a power supply 112 that also provides power to one or more adjacent welding skids 100 (i.e., “slaves”) within the weld assembly 150.

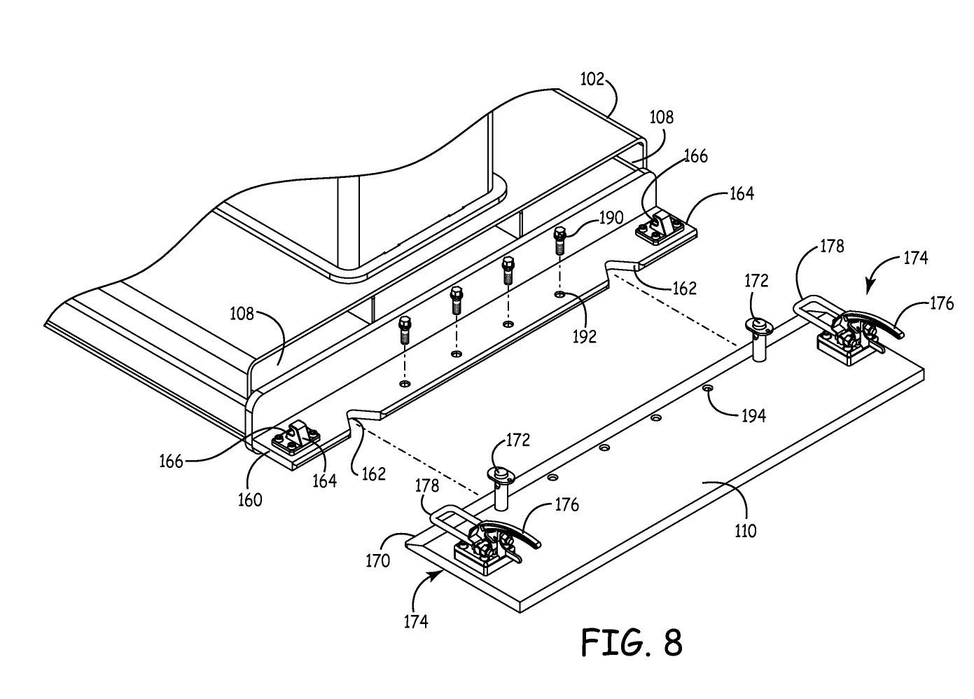

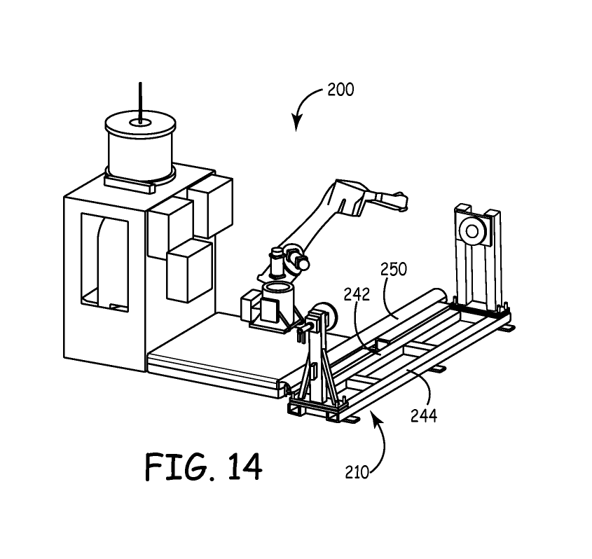

FIGS. 7 and 8 show the welding skid 100 coupled to the fixture 110. The fixture 110 can be fixed to a support surface such as the floor. In the illustrated embodiment, the fixture 110 is an elongated flange that can accommodate coupling to multiple welding skids 100 adjacent to one another. Each welding skid 100 can be separately coupled to the fixture 110 and can be de-coupled and removed from the fixture 110 without removing adjacent welding skids 100. In other embodiments, the fixture 110 can also be configured for holding and/or positioning a structure to be welded by the weld robot 104 (see FIG. 14).

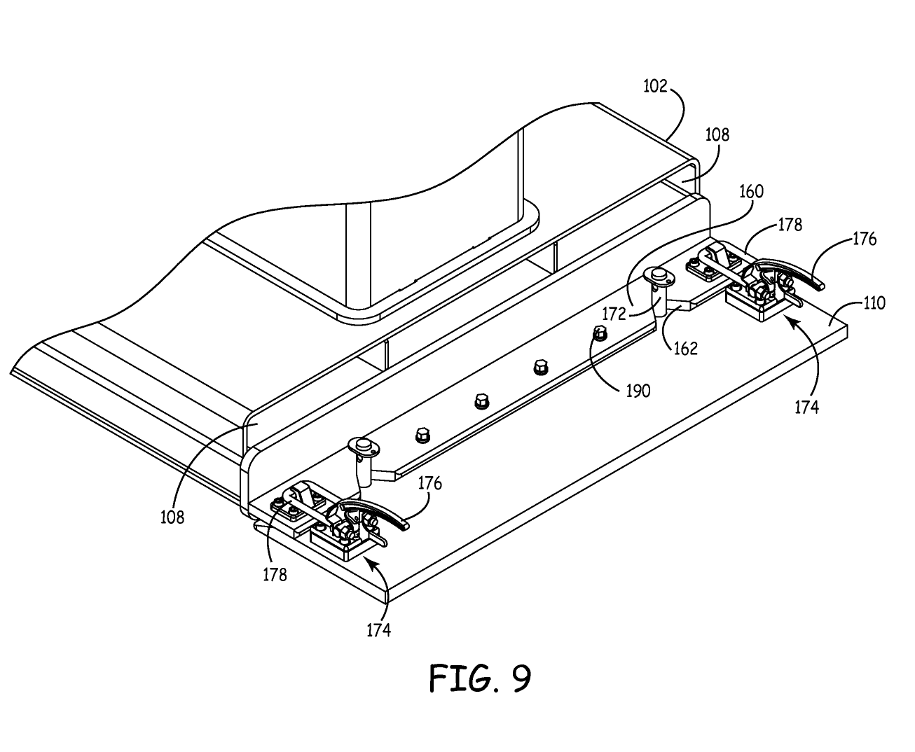

The welding skid 100 includes a mounting flange 160 for coupling the welding skid 100 to the fixture 110. FIG. 9 is an enlarged perspective view of the mounting flange 160 spaced apart and un-coupled from the fixture 110. The mounting flange 160 is slightly elevated from a lower plane of the base 102 to define a gap between an underside of the flange 160 and the support surface. Pairs of V-shaped notches 162 are cut into the flange 160 at regular intervals. A mounting block 164 is positioned adjacent to each of the notches 162 near the outer sides of the flange 160. The mounting block 164 can be integrally formed with the flange 162, or as is illustrated in FIG. 8, can be fixed to the flange 160. The mounting block 164 includes a C-shaped cutout 166 facing towards the rear of the base 102 (i.e., away from the fixture 110).

The fixture 110 includes a forward edge 170 that slopes downwardly away from the fixture 110. Locator studs 172 extend upwardly from the fixture 110 at regularly spaced intervals. A mounting mechanism 174 is positioned adjacent to each of the locator studs 172. Each of the mounting mechanism 174 includes a lever 176 operably coupled to a U-shaped connecting bar 178 with a linkage 180. The spacing between the locator studs 172 is approximately equal to the spacing between the notches 162 of the flange 160. Likewise, the spacing between the mounting mechanisms 174 is approximately equal to the spacing between the mounting blocks 164.

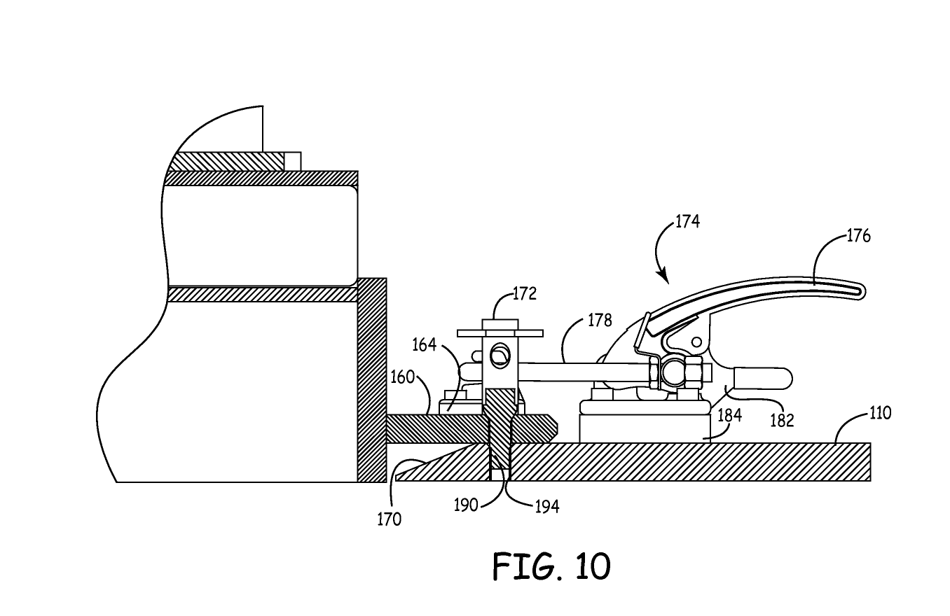

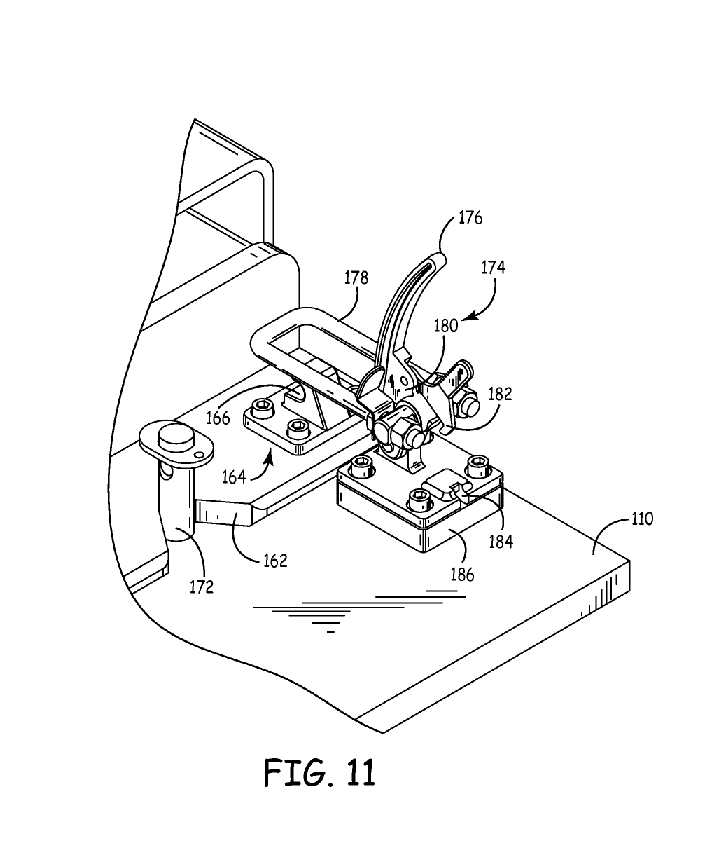

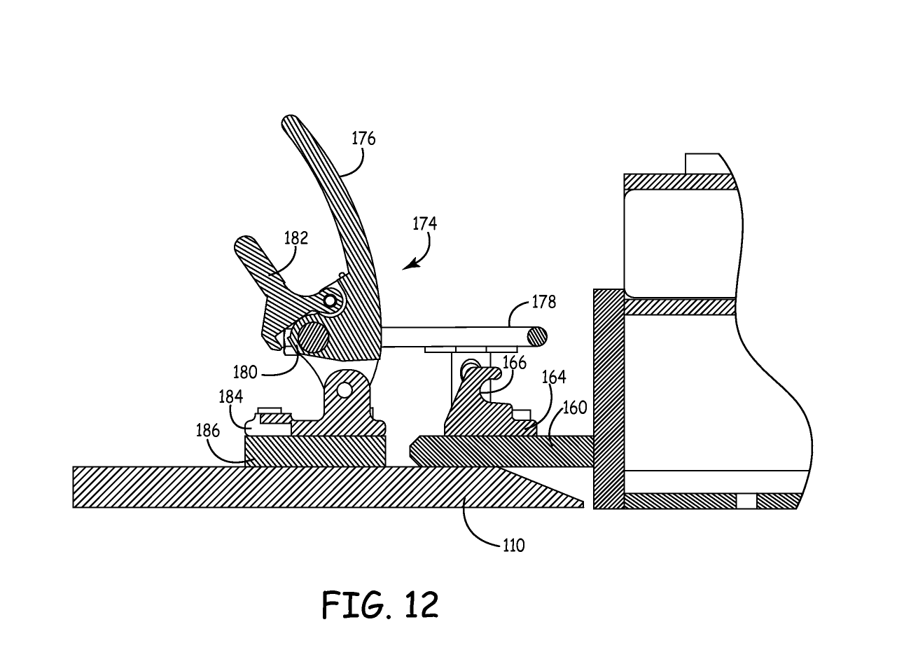

As shown in FIGS. 9-12, the welding skid 100 is coupled to the fixture 110 by positioning the mounting flange 160 of the welding skid 100 adjacent to the sloped face 170 of the fixture 110. The welding skid 100 can be moved via the packets 108 with a fork-lift into position adjacent the fixture 110. The welding skid 100 is positioned relative to the fixture 110 so that the notches 162 are approximately aligned with the locator studs 172. The welding skid 100 is moved towards the fixture 110 such that as the flange 160 approaches the fixture 110, the flange 160 slides over the sloped face 170 of the fixture 110 and the V-shaped notches 162 slide over the locator studs 172. The welding skid 100 self-aligns laterally relative to the fixture 110 to locate the locator studs 172 at the apex of the V-shaped notches 162. With the locator studs 172 and the v-shaped notches 162 aligned to one another, the mounting mechanisms 174 are aligned with the corresponding mounting blocks 164.

With the lever 176 of the mounting mechanism 174 in a first or unlocked orientation, the U-shaped connecting bars 178 slide over the top of the mounting blocks 164 so that a forward, middle portion of the connecting bars 178 is adjacent to the C-shaped cutout 166 in the mounting block 164. To secure the welding skid 100 to the fixture 110, the lever 176 is actuated by moving downwardly into a second or locked orientation. As the lever 176 moves downwardly, a pivoting link 182 pivotably coupled to the lever 176 is captured in a slot 184 in a base 186 of the mounting mechanism 174. As the lever 176 continues to move downwardly to the locked orientation, the U-shaped connecting bar 178 is captured in the C-shaped cutout 166 of the mounting block 164. Because the fixture 110 is fixed to the support surface or is otherwise immobilized, as the lever 176 continues to pivot downwardly via the linkage 180, the connecting bar 178 pulls the base 102 toward the fixture 110 so that the flange 160 slides over the sloped face 170. As the lever 176 is pivoted fully into the locked orientation, the weld skid 100 is securely coupled to the fixture 110. The lever 176 may include an over center feature to prevent the mounting mechanism 174 from inadvertently releasing the mounting block 164. The mounting mechanism 175 may also include a lock or other feature to positively prevent the lever 176 from moving upwardly to inadvertently release the mounting block 164.

In the illustrated embodiment, the mounting base 164 is located on the base 102 of the welding skid 100 and the mounting mechanism 174 is located on the fixture 110. In other embodiments, the mounting base 164 is located on the fixture 110 while the mounting mechanism 174 is located on the base 102.

Additional mounting bolts 190 may be used to secure mounting flange 160 to the fixture 110 at aligned apertures 192, 194. The welding skid 100 may include additional mounting feet 196 along the lateral or rear edge of the base 102 for securing the welding skid 100 directly to the support surface. This can help to reduce shifting of the welding skid 100 due to vibration. To de-couple the welding skid 100 from the fixture 110, the above steps are reversed. That is, the mounting bolts 180 are removed and the lever is pivoted upwardly to the unlocked orientation.

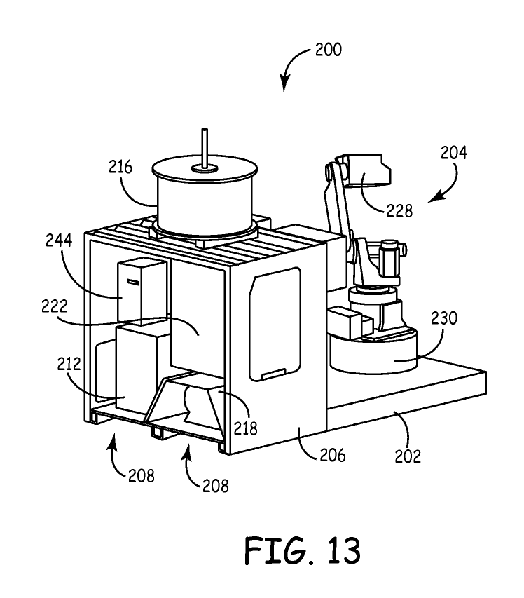

FIG. 13 illustrates a perspective view of welding skid 200 according to another embodiment of the invention. Welding skid 200 includes a base 202 supporting a weld robot 204 and a cabinet 206. The base 202 includes a standardized skid dimension that allows for the engagement of a fork lift for transport of the welding skid 100. Therefore, base 202 includes stake packets 208 to facilitate transport by a fork lift.

Various components can be located within the base 202, including a weld power supply 212, a wire feeder 214 that feeds wire from a weld wire spool 216, a weld torch water cooler 218, a reamer 220, at least one control housing 222, and an electrical disconnect panel 224. All or a portion of a rear of the cabinet 206, illustrated in FIG. 13, can be open to permit access to components stored within the cabinet 106. In alternate embodiments, one or more components can be located outside of the cabinet 106. For example, the weld power supply 212 can be mounted to an outer wall of the cabinet 206 for ease of access. The weld wire spool 216 can be located on a top wall or roof of the cabinet 206 for ease of access.

The weld robot 204 has a robotic arm 228 positioned on a riser 230 in front of the cabinet 206. All utilities, such as power, compressed air and shielding gas, are provided to various types of components mounted to base 204 and are routed internal to base 204. Specifically, these utilities can be located at a common location and cab use a combined drop (not shown).

In operation, controls in control housing 222 are configured to control the movement and action of weld robot 204 for welding a component. In addition, controls in control housing 222 also control various functions of providing weld material to robot 204. For example, all aspects of supplying power from weld power supply 212 and cooling the weld torch on robotic arm 228 with weld torch water cooler 218 are controlled by controls in control housing 222.

FIG. 14 shows the welding skid 200 coupled to a fixture 210 that is configured for retaining a component that needs welding. Fixture 210 includes a first side 242 and a second side 244 opposite first side 242. Fixture 210 is couplable to a base 202 of welding skid 200 on first side 242 of fixture 210. A removable cover 250 can be utilized to protect the connection between base 202 of welding skid 200 and fixture 210 from weld material spatter. Cover 250 can also be utilized to protect cables originating from various components mounted to base 202. Cover 250 is strong enough to not deform under a load bearing weight of a person.

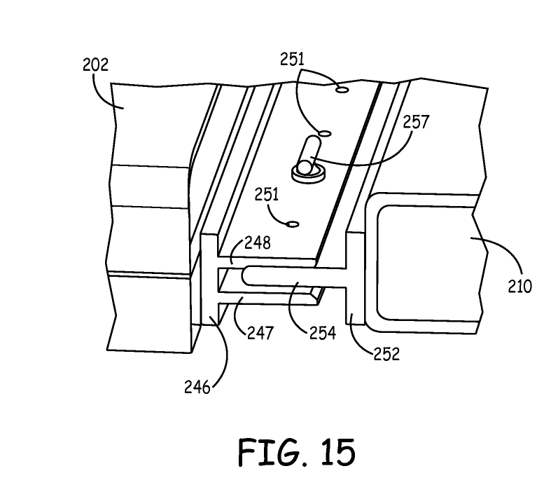

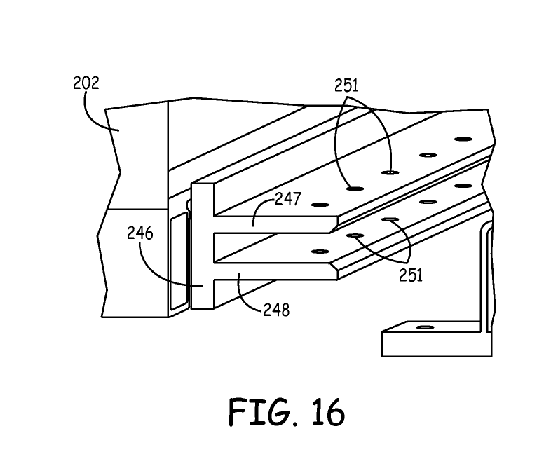

FIG. 15 is an enlarged perspective view of the connection between the welding skid 200 and the fixture 210. Although FIG. 15 illustrates the fixture as being fixture 210, it should be realized that the fixture can be other types of fixtures. The base 202 includes a female connector 246. Female connector 246 includes first and second flanges 247 and 248 which are spaced apart from each other. Each of first and second flanges 247 and 248 include a plurality of apertures 251. Each aperture 251 on first flange 248 is in alignment with an aperture 251 on second flange 250. Apertures 251 are clearly illustrated in FIG. 16.

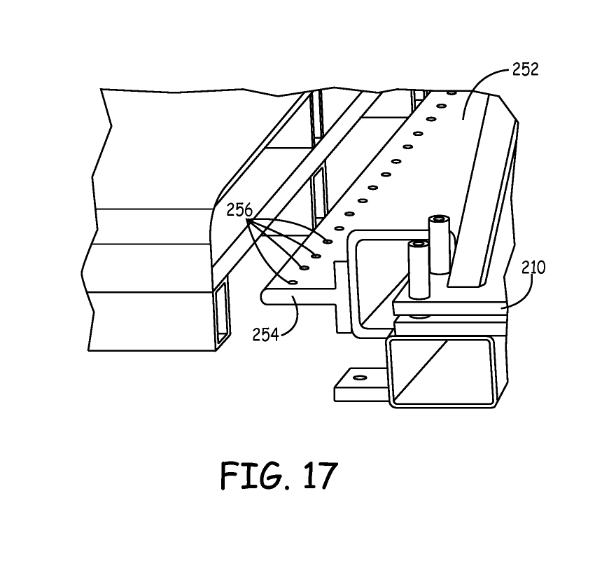

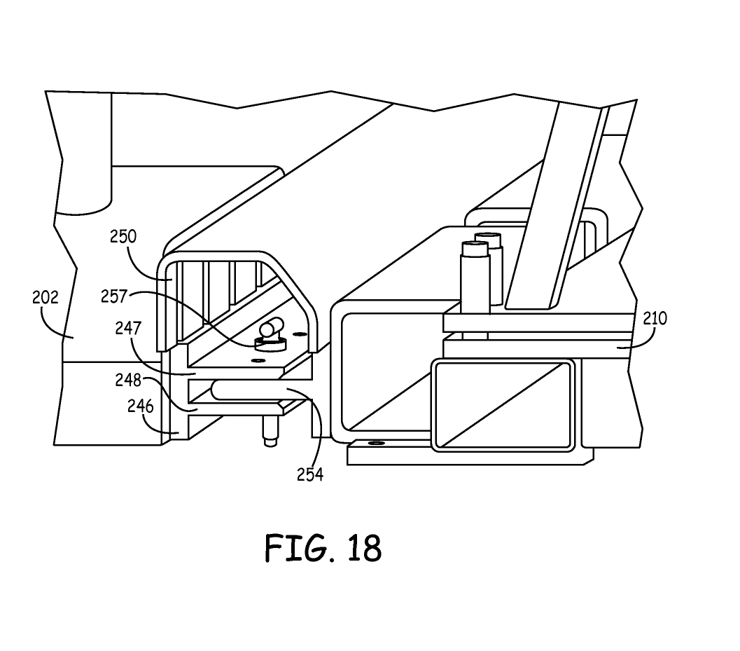

As shown in FIG. 17, fixture 210 includes a male connector 252. Male connector 252 includes a tongue 254. Tongue 254 also includes a plurality of apertures 256 (illustrated in FIG. 13). Tongue 254 is configured to be inserted between first and second flanges 247 and 248. As shown in FIG. 18, each aperture 256 of tongue 254 is put into alignment with each aperture 251 which are in alignment on first and second flanges 247 and 248. Female connector 246 and male connector 252 are locked together using at least one lock pin 257. In general, lock pins 257 can be placed along the length of female and male connectors 246 and 252. Each lock pin 257 is inserted into each aperture 251 and each aperture 256, which are in alignment. Each lock pin 257 can be turned into a locking position.

Although the present invention has been described with reference to preferred embodiments, workers skilled in the art will recognize that changes may be made in form and detail without departing from the spirit and scope of the invention.

Thus, the invention provides, among other things, a modular robotic welding skid. Various features and advantages of the invention are set forth in the following claims.

What is claimed is:

1. A robotic welding skid for performing welding functions, the welding skid comprising:
a base configured for coupling to a vehicle for transport;
a robotic weld arm supported on the base;
a power supply supported on the base for supplying power to the robotic arm;
a dedicated controller supported on the base for controlling operation of the robotic weld arm;
at least one drop for receiving a utility external to the welding skid; and
a mounting flange configured for coupling the base to a fixture.

2. The robotic welding skid of claim 1, wherein the base includes stake packets configured for receiving a fork lift.

3. The robotic welding skid of claim 1, further comprising a cabinet supported on the base rearwardly of the robotic weld arm.

4. The robotic welding skid of claim 1, further comprising a connector for connecting the power supply, the controller and the robotic weld arm, the connector being routed internal to the base.

5. The robotic welding skid of claim 1, wherein the mounting flange is located on a forward edge of the base adjacent to the robotic weld arm.

6. The robotic welding skid of claim 1, wherein the mounting flange includes a V-shaped recess configured for receiving a cooperating stud on the fixture for aligning the base 102 to the fixture.

7. The robotic welding skid of claim 1, wherein the mounting flange includes at least one of a mounting base and mounting mechanism.

8. A weld assembly comprising:
a fixture including a plurality of mounting mechanisms; and
a plurality of modular welding skids operable in concert with one another to perform coordinated welding functions, each welding skid including:
a base configured for coupling to a vehicle for transport;
a robotic weld arm supported on the base;
a power supply supported on the base for supplying power to the robotic arm;
a dedicated controller supported on the base for controlling operation of the robotic weld arm;
at least one drop for receiving a utility external to the welding skid; and
a mounting flange configured for coupling the base to at least one of the mounting mechanisms of the fixture.

9. The weld assembly of claim 8, further comprising a first welding skid and a second welding skid, wherein the controller of the first welding skid is capable of controlling operation of the associated robotic weld arm independently of the controller of the second welding skid.

10. The weld assembly of claim 8, further comprising a first welding skid and a second welding skid, wherein the first welding skid is capable of being de-coupled from the fixture while the second welding skid remains coupled to the fixture.

11. The weld assembly of claim 8, further comprising a first welding skid and a second welding skid, wherein the power supply of the first welding skid is connected to the second welding skid for supplying power to the robotic arm of the second welding skid.

12. The weld assembly of claim 8, wherein the fixture includes pairs of mounting mechanisms, each pair of mounting mechanisms being configured for coupling a welding skid to the fixture.

13. The weld assembly of claim 8, wherein the fixture is configured for holding a component for welding by the welding skids.

14. The weld assembly of claim 8, wherein the base includes stake packets configured for receiving a fork lift.

15. The weld assembly of claim 8, wherein the mounting flange is located on a forward edge of the base adjacent to the robotic weld arm.

16. A method of assembling a plurality of robotic weld arms for working in concert with one another to perform welding functions on a component, each welding skid including a base configured for coupling to a vehicle for transport, a robotic weld arm supported on the base, a power supply supported on the base for supplying power to the robotic arm, a dedicated controller supported on the base for controlling operation of the robotic weld arm and at least one drop for receiving a utility external to the welding skid, the method comprising:
affixing a fixture to a support surface;
coupling a first welding skid to the fixture;
programming the controller of the first welding skid to operate the robotic weld arm of the first welding skid to perform desired welding functions;
coupling a second welding skid to the fixture; and
programming the controller of the second welding skid to operate the robotic weld arm of the second welding skid to perform desired welding functions, the controller of the second welding skid operating independently of the first welding skid.

17. The method of claim 16, further comprising:
de-coupling the second welding skid from the fixture while the first welding skid remains coupled to the fixture;
coupling a replacement welding skid to the fixture in a same location as the second welding skid; and
programming the controller of the replacement welding skid to operate the robotic weld arm of the replacement welding skid to perform desired welding functions.

18. The method of claim 16, further comprising mounting a component to be welded by the first and second welding skids to the fixture.

19. The method of claim 16, wherein coupling the welding skids to the fixture includes aligning each welding skid to a pre-determined location relative to the fixture.

20. The method of claim 16, wherein coupling each welding skid to the fixture includes coupling the welding skid to a mounting mechanism on the fixture, the mounting mechanisms being regularly spaced apart from one another.
